(19) United States
(12) Patent Application Publication
(10) Pub. No.: US 2009/0067343 A1
(43) Pub. Date: Mar. 12, 2009

(54) Method for the synthesis of optimal asynchronous on-chip communication networks from system-level constraints

(76) Inventor: David Fritz, (US)

Correspondence Address: MICHAEL W. CALDWELL, 4226 RIVERMARK PARKWAY, SANTA CLARA, CA, 95054-4150, US

(21) Appl. No.: 11/809,995

(22) Filed: Jun. 4, 2007

(51) Int. Cl. H04L 12/28

(52) U.S. Cl. 370/254

(57) ABSTRACT

The invention provides chip designers a means to take advantage of ANoC interconnect, the combination of the two technologies, asynchronous circuits and Network on Chip (ANoC), enabling them to design large chips more easily and quickly than before. The designer develops a table of interconnect requirements, specifying the desired connections and certain constraints such as area, power, and latency. The invention develops a connectivity network utilizing a library of characterized components, then optimizes the network by selecting various alternative components from the library and examining alternative link width combinations. The optimized network is verified against the predetermined requirements. If the verification is successful a fabric file is provided. If the verification is not successful the optimization process is repeated provided some improvement has been made.

### COMPUTER PROGRAM LISTING APPENDIX

The computer program listing appendix attached hereto consists of two (2) identical compact disks, Copy 1 and Copy 2, created by a personal computer operated under a Windows XP operating system, each disc containing a listing of the software code for one embodiment of the components of this invention. Each compact disk contains the following files (by file name, size in bytes, and date and time of creation):

| [File name] | [Size] | | [Save date] |
|---|---|---|---|
| addchr.c | 2059 | Byte | 2006-12-27 21:48:44 |
| addident.c | 1685 | Byte | 2007-03-17 20:27:18 |
| addstr.c | 1750 | Byte | 2007-03-06 22:44:26 |
| attrib.h | 979 | Byte | 2007-05-30 13:46:28 |
| cleanup.c | 1708 | Byte | 2007-02-05 10:51:30 |
| define.c | 7451 | Byte | 2006-12-27 21:48:12 |
| defines.h | 2322 | Byte | 2007-05-31 08:18:30 |
| directive.c | 2246 | Byte | 2006-12-27 21:48:04 |
| enterfile.c | 4957 | Byte | 2006-12-27 21:47:58 |
| epartab.c | 4796 | Byte | 2006-12-27 21:47:50 |
| errordir.c | 1458 | Byte | 2006-12-27 21:47:44 |
| errors.c | 17415 | Byte | 2007-05-30 14:51:02 |
| errors.h | 510 | Byte | 2006-12-27 21:42:30 |
| estimator.c | 28361 | Byte | 2007-05-31 08:30:40 |
| evalpred.c | 287 | Byte | 2007-05-31 10:27:58 |
| evalstr.c | 18727 | Byte | 2007-04-04 13:59:12 |
| externs.h | 2574 | Byte | 2007-05-17 21:28:44 |
| fabric.c | 245896 | Byte | 2007-05-30 21:28:32 |
| fltconst.c | 1644 | Byte | 2006-12-27 21:47:08 |
| global.c | 8495 | Byte | 2007-05-31 08:34:52 |
| global.h | 7273 | Byte | 2007-05-31 08:18:30 |
| heapchk.h | 513 | Byte | 2006-12-27 21:41:36 |
| ifdir.c | 7255 | Byte | 2007-02-27 19:23:54 |
| include.c | 3913 | Byte | 2007-01-22 16:16:40 |
| init.c | 4248 | Byte | 2007-05-17 13:05:18 |
| intconst.c | 4459 | Byte | 2006-12-27 21:46:28 |
| lexsem.c | 4183 | Byte | 2007-05-31 10:27:58 |
| lextab.c | 92710 | Byte | 2007-05-31 10:28:02 |
| lextab.h | 131 | Byte | 2007-05-31 10:28:02 |
| linedir.c | 2117 | Byte | 2006-12-27 21:46:06 |
| macexp.c | 11351 | Byte | 2007-02-21 06:21:56 |
| memory.c | 3376 | Byte | 2006-12-27 21:43:18 |
| memory.h | 1004 | Byte | 2006-12-27 21:40:34 |
| normalize.c | 1391 | Byte | 2006-12-27 21:45:48 |
| nsf new.c | 57506 | Byte | 2007-05-30 20:58:50 |
| nsf.c | 58253 | Byte | 2007-05-31 10:27:56 |
| parsem.c | 67199 | Byte | 2007-05-31 10:27:58 |
| partab.c | 35034 | Byte | 2007-05-31 10:28:02 |
| partab.h | 299 | Byte | 2007-05-31 10:28:02 |
| port.c | 6620 | Byte | 2007-05-30 22:31:34 |
| port.h | 906 | Byte | 2007-05-30 22:30:46 |
| ppscan.c | 3283 | Byte | 2006-12-27 21:45:24 |
| pptoken.c | 5968 | Byte | 2007-02-27 19:57:00 |
| pragma.c | 4550 | Byte | 2007-05-07 15:13:16 |
| proto.h | 10266 | Byte | 2007-05-30 15:00:52 |
| qsort.c | 2499 | Byte | 2006-12-28 21:33:36 |
| setstuff.c | 6994 | Byte | 2006-12-27 21:44:52 |
| setstuff.h | 1035 | Byte | 2006-12-27 21:39:52 |
| structs.h | 13806 | Byte | 2007-05-30 15:51:50 |
| switches.h | 604 | Byte | 1998-03-05 01:30:00 |
| symtab.c | 15159 | Byte | 2006-12-27 21:44:44 |
| symtab.h | 510 | Byte | 2006-12-27 21:39:16 |
| tokens.h | 2986 | Byte | 2007-05-31 10:27:58 |
| transtr.c | 5052 | Byte | 2006-12-27 21:44:36 |
| transtr.h | 553 | Byte | 2006-12-27 21:38:38 |
| undef.c | 1432 | Byte | 2006-12-27 21:44:28 |
| utils.c | 108549 | Byte | 2007-05-31 08:33:22 |
| version.h | 659 | Byte | 2007-05-30 15:05:02 |

Total number of files = 58
Sum of file sizes = 908966 Byte

### BACKGROUND

Since the introduction of VLSI circuits, simple bus structures have been used to transfer data between processing blocks within a computer chip. To date, Time Division Multiplexing (TDM) methods of partitioning data transmission bandwidth have been effective in implementing bus architectures for on-chip communications.

Such methods have progressively become less effective as die sizes and clocking frequencies have increased, making if difficult for data to be propagated along long wires within a single clock period. Complex pipelined, hierarchical bus schemes with bridges, synchronizers and large buffers are sometimes used to extend the reach of conventional bus methods at the cost of additional complexity and increased power consumption and chip area.

With very deep submicron manufacturing processes providing the means to manufacture an extremely large number of gates and with wire delay dominating timing concerns, the continued use of traditional bus methods has increased time to market at a time when economic forces driven by consumer demand require shorter development cycles, more features, lower power and lower overall cost. This combination of inflection points in the semiconductor industry has stressed conventional bus methodologies to the point of becoming impractical and necessitates a completely new approach to on-chip communication.

Two recent advancements have been introduced in the literature, one in design methodology and another in circuit implementation, addressing fundamental aspects of the on-chip interconnect problem. One advancement, typically referred to as “Network on Chip” (NoC) is a design methodology that is directed to the use of a networking paradigm to combine on-chip data into packets that are routed synchronously (on clock edges) through various switches within the network to a target processing logic block. While this method addresses some issues of the fundamental interconnect problem it still suffers from many of the same failings of conventional bus architectures while introducing new issues including large latency, area and power penalties, and wire congestion.

The problems associated with a NoC implemented with a synchronous approach may be resolved with another advancement in this field: on-chip interconnect using clockless (also known as “asynchronous” or “self-timed”) circuits to implement interconnect hardware. This circuit methodology combination, denominated “Asynchronous Network on Chip” (ANoC) offers several advantages over conventional synchronous busses with synchronous NoCs. For example, data can be transmitted across long chip distances and through control logic without waiting for a clock edge, making the data transmission rate across a chip completely independent of system clock frequencies. Unlike synchronous implementations, where flip-flops are used to span long distances adding latency and increasing area and power, asynchronous circuits can span these distance easily thereby providing improved top-level timing closure and lower overall design complexity.

Another advantage of interconnect implemented using asynchronous circuits is that, unlike synchronous circuits, no power is consumed unless data is being transmitted, thereby automatically eliminating the need for power or clock gating in the interconnect itself, further reducing design complexity.

However, an impediment to the widespread adoption of ANoC for chip interconnect is the necessity for designers to undergo a significant paradigm and methodology shift in how chip communication systems are thought of and implemented. While the behavior of TDM based busses can be complex, they are well understood, often simple enough to be described in a spreadsheet. On the other hand, ANoC technology requires a sophisticated understanding of asynchronous circuit behavior and a distributed view of how latency and bandwidth impact system performance. Manual exploration and implementation of ANoC interconnect for a particular design, or family of designs, can be extremely difficult using conventional methods.

### SUMMARY

The method of the invention provides chip designers a means to take advantage of ANoC interconnect, the combination of the two technologies, asynchronous circuits and Network on Chip (ANoC), enabling them to design large chips more easily and quickly than before. In designing with ANoC it is not obvious how much performance, power and area a complex ANoC implementation will require. The method of the present invention addresses this by producing a comprehensive report file with accurate power, area and performance estimates that are derived directly from a library of pre-characterized hardware components.

The invention provides a method of synthesizing an optimal ANoC interconnect design, using system requirements presented by a chip architect in a commonly used format, thereby removing the architect's need to understand either asynchronous circuit design or NoC peculiarities while affording the benefits of ANoC technology. Design requirements are combined with data from a component library to provide a listing of requirements understandable by system software. Certain components are selected to derive a connectivity network. The connectivity network is optimized, then verified against the requirements list. If the network is verified to satisfy the requirements a network fabric is provided in a standard data format for use in a target design. If the network is not verified to satisfy the requirements list, the network is optimized again by modifying the selection of components and the links connecting them, provided the instant iteration of the process is an improvement compared to the previous iteration. If the instant iteration has not provided improvement and has not been successfully verified then no solution that satisfies the requirement list can be found and an error listing is generated.

### BRIEF DESCRIPTION OF THE DRAWINGS

FIG. 1 is a top level flow chart in accordance with the present invention.

FIG. 2 shows data being attached to a network component port.

FIG. 3 is a flow chart of an example of a process for deriving a connectivity network.

FIG. 4 is a flow chart of an example of a process for deriving a cluster in accordance with the present invention.

FIG. 5 is a flow chart of an example of a process for switch insertion in accordance with the present invention.

FIG. 6 is a flow chart of an example of a process for finding components in accordance with the present invention.

FIG. 7 is a flow chart of an example of a process for optimizing a network in accordance with the present invention.

FIG. 8 is a flow chart of an example of a slack calculation process in accordance with the present invention.

FIG. 9 is a flow chart of an example of a simple optimization process in accordance with the present invention.

FIG. 10 is a flow chart of an example of a switch balancing process in accordance with the present invention.

FIG. 11 is an example flow chart for deriving complex components in accordance with the present invention.

FIG. 12 is a flow chart of an example of a depth first ordering process in accordance with the present invention.

FIG. 13 is a flow chart of an example of an optimization decision process in accordance with the present invention.

FIG. 14 is an example flow chart of a process for fixing up slack in a network in accordance with the present invention.

FIG. 15 is an example flow chart for optimizing utilizations. in accordance with the present invention.

FIG. 16 is an example flow for inserting one or more SERDES into a network in accordance with the present invention.

FIG. 17 is an example flow for verifying a network in accordance with the present invention.

### DESCRIPTION OF SOME EMBODIMENTS

### Definition of Terms

| | |
|---|---|
| ANoC | Asynchronous Network on Chip |
| Flit | Packet length divided by the width of a certain link |
| Elaborating | Making a copy of a component from a component |
| | library in the fabric of a network. |
| SERDES | Serializer/deserializer circuit |

### Building Blocks of ANoC Fabrics

ANoCs comprise four basic components: protocol adaptors, transmit components, receive components, switches and serializers/deserializers. Protocol adaptors are synchronous logic that packetize bus protocol signals into packets to be sent across a network. Protocol adaptors send signals to transmit components and receive signals from receive components. Transmit components cross from the synchronous domain into the asynchronous domain and place packet signals onto the asynchronous fabric. Receive components do the reverse: they take signals off the asynchronous fabric and move them into the synchronous domain to be depacketized by a protocol adaptor. Switches reside entirely in the asynchronous domain and control the routing and distributed arbitration of packets sent across the fabric.

Serializers/deserializers (SERDES) serialize packet signals when going from a wide portion of an asynchronous fabric to a narrower portion of the fabric. SERDES also perform the opposite task, parallelizing serial signals by using buffering techniques when a narrow portion of the fabric merges with a wider portion of the fabric. Since ANoCs allow arbitrary serialization/deserialization of packets, not all components of the network must be the same width, and few, if any, are able to handle a complete packet of information at once. To accommodate this, the concept of a flit is introduced. A flit is some portion of a packet that can be transmitted along a network link in parallel. The size of a flit is determined entirely by the width of the instant link through which the packet must travel. For example, a thirty-two bit packet carried by a four-bit link (the bus width of the link) would be partitioned into eight flits for transport on the link. If the next link were sixteen bits wide a SERDES would provide the link with two sixteen bit flits. Typically, a packet will pass through several links with different widths while traveling across a network. Therefore, different portions of the network will require varying numbers of flits to transmit an entire packet.

### Component Library and System Communication Requirements

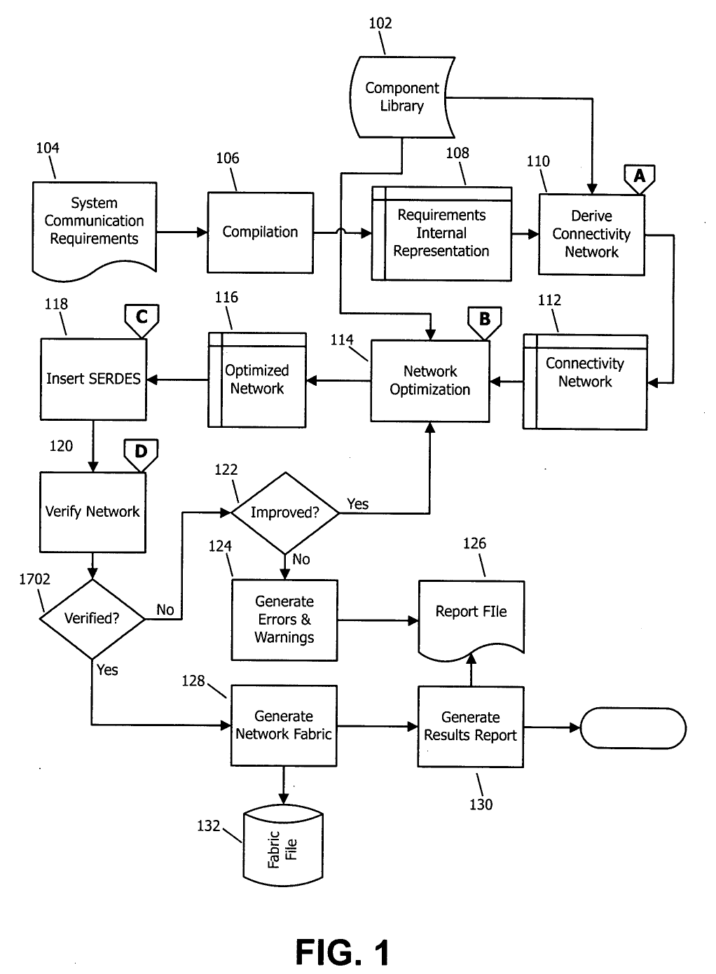

Referring to FIG. 1, a component library 102 is a data set which lists the hardware components from which an ANoC may be constructed and the attributes associated with each component. An example of component types and their attributes is shown in Table 1. The method of the invention must be capable of producing an optimized ANoC using any subset of components in the component library. The component list is provided by a silicon vendor, licensed intellectual property, or the chip designer.

TABLE 1
Component Library Example

| Description | Name | Units |
|---|---|---|
| Protocol Adaptor | A_{0...n} | |
| Protocol Name | Aₙ.n | String |
| Energy | Aₙ.e | Milliwatts/MHz |
| Width | Aₙ.w | Bits |
| Area | Aₙ.a | Kgates |
| Transmit Component | TX_{0...n} | |
| Input ports | TXₙ.i | |
| Width of component | TXₙ.w | Bits |
| Area | TXₙ.a | Kgates |
| Energy | TXₙ.e | Picojoules/flit |
| Bandwidth | TXₙ.b | Megabits/sec |
| Setup Latency | TXₙ.ls | Nanoseconds |
| Flit Latency | TXₙ.lf | Nanoseconds |
| Receive Component | RX_{0...n} | |
| Output ports | RXₙ.o | |
| Width of component | RXₙ.w | Bits |
| Area | RXₙ.a | Kgates |
| Energy | RXₙ.e | Picojoules/flit |
| Bandwidth | RXₙ.b | Megabits/sec |
| Setup Latency | RXₙ.ls | Nanoseconds |
| Flit Latency | RXₙ.lf | Nanoseconds |
| Switch | S_{0...n} | |
| Width of component | Sₙ.w | Bits |
| Area | Sₙ.a | Kgates |
| Energy | Sₙ.e | Picojoules/flit |
| Bandwidth | Sₙ.b | Megabits/sec |
| Input ports | Sₙ.i | |
| Output ports | Sₙ.o | |
| Arbitration Latency | Sₙ.la | Nanoseconds |
| Route Latency | Sₙ.lr | Nanoseconds |
| Fanout Latency | Sₙ.lo | Nanoseconds |
| Switching Latency | Sₙ.ls | Nanoseconds |
| Setup Latency | Sₙ.lu | Nanoseconds |
| Flit Latency | Sₙ.lt | Nanoseconds |
| Serializer/Deserializer | SD_{0...n} | |
| Area | SDₙ.a | Kgates |
| Energy | SDₙ.e | Picojoules/flit |
| Bandwidth | SDₙ.b | Megabits/sec |
| Input width | SDₙ.i | Bits |
| Output width | SDₙ.o | Bits |
| Setup Latency | SDₙ.ls | Nanoseconds |
| Flit Latency | SDₙ.lf | Nanoseconds |

A chip designer provides a list of requirements by providing a data set denominated the “system communication requirements” 104, described in more detail hereinafter. A compiler 106 reformats the system communication requirements 104 and component library 102 into a file format expected by the system software of the invention, the output file denominated the “requirements internal representation” 108. The compilation process uses conventional lexical analysis, parsing, and syntax directed translation techniques to take a textual representation of a chip's high-level architectural requirements and compiles them into an internal representation stored in RAM. While the invention is not restricted for use with any input language or syntax, certain inputs related to the chip architecture are required. These are listed in Table 3.

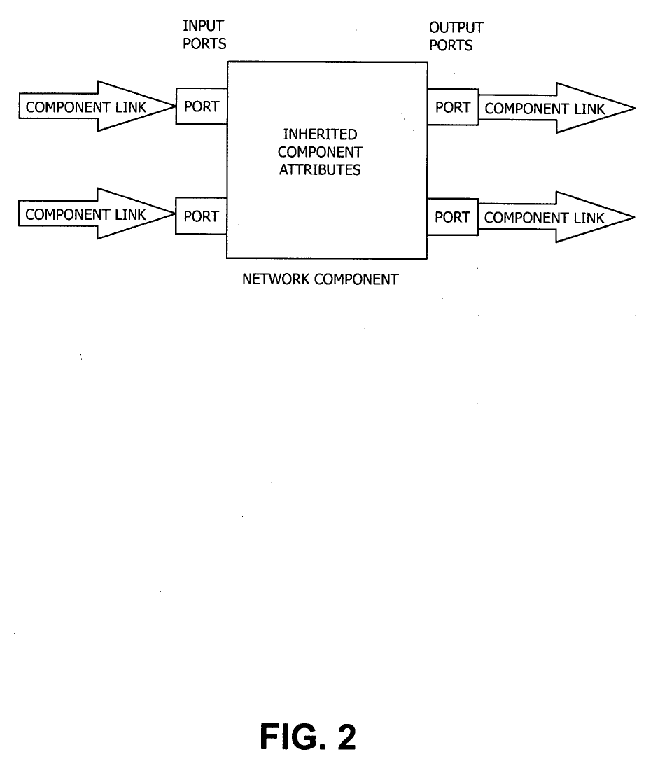

The component library 102 us comprised entirely of fabric components characterized for a particular silicon manufacturing process node. When a fabric is constructed, components from the library are elaborated and inherit all of the attributes of the library component from which it was elaborated. The inputs and outputs of a component are conceptualized as “ports”, wherein network components each have ports for each input and output of the component as shown in FIG. 2. Input ports of a network component are pointed to by the output ports of other network components. Output ports of a network component point to the input ports of other network components. Ports also associate inherited component attributes of the component which are used during the network optimization process 114. An example of the data attached to each network component port is shown in Table 2.

TABLE 2
Example of Network Component Port Attributes

| Description | Name | Units |
|---|---|---|
| Description | Name (for component Cn) | Units |
| Width of Port | Cn.Pm.w | Bits |
| Utilization Percentage | Cn.Pm.u | |
| Latency Slack | Cn.Pm.s | Nanoseconds |
| Duty Cycle Percentage | Cn.Pm.d | |
| Period of Cycle | Cn.Pm.p | Nanoseconds |
| Command Depth | Cn.Pm.c | |
| Response Depth | Cn.Pm.r | |
| Utilization Threshold | Cn.Pm.t | |
| Percentage | | |
| Flits | Cn.Pm.f | |
| Input Component Port | Cn.Pm.i | |
| Output Component Port | Cn.Pm.o | |

The compilation process uses conventional lexical analysis, parsing, and syntax directed translation techniques to take a textual representation of a chip's high-level architectural requirements and compiles them into an internal representation stored in RAM. While the invention is not restricted for use with any input language or syntax, certain inputs related to the chip architecture are required. These are listed in Table 3.

Referring to FIG. 1, a process flow is shown wherein a list of system communication requirements 104 is provided by a chip designer to be compiled into a representation of the requirements in a format useable to a program implementing the method of the present invention. An example of a requirements internal representation 108 is shown in Table 3. To avoid ambiguity and provide flexibility, there may be any number of clock domains Dn described in the system communication requirements input 104. Each clock domain Dn may have any number of processing blocks Dn.Bm within it. Requirement specifications may include a list of no more than n² connections (where n is the number of processing blocks in the system) as well as constraint information for each connection. For example, using the example of Table 3, suppose a first clock domain (n=0) has a frequency of 5 MHz (D0.f=5), and the clock of this instant domain (D0) is provided to a circuit block including five processing blocks, the second of which (D0.B1) must receive data packets at up to 20 megabits per second (D0.B1.p=20). The components library may include, for example, three receive blocks, and suppose the third one (RX3) has been characterized to be capable of receiving 24 megabits per second (RX3.b=24). The other attributes of RX3 are also given by the components library, including its bit width, area, setup latency, etc. This simple example illustrates how a designer may fully describe the system requirements for an ANoC network. The descriptive process is continued by the designer until all blocks to be interconnected by the ANoC method are described.

TABLE 3
System Communications Requirements Example

| Description | Name | Units |
|---|---|---|
| List of clock domains | D_{0...n} | |
| Clock frequency | Dₙ.f | Megahertz |
| List of processing blocks | Dₙ.B_{0...n} | |
| Data size | Dₙ.Bₘ.d | Bits |
| Address size | Dₙ.Bₘ.a | Bits |
| Largest packet | Dₙ.Bₘ.b | Bits |
| Peak bandwidth | Dₙ.Bₘ.p | Megabits/Sec |
| Typical bandwidth | Dₙ.Bₘ.t | Megabits/Sec |
| Packet protocol | Dₙ.Bₘ.c | |
| Transmit component | Dₙ.Bₘ.tx | |
| Receive component | Dₙ.Bₘ.rx | |
| List of connections containing | L_{0...n} | |
| The sender logic block | Lₙ.s | |
| The receiver logic block | Lₙ.r | |
| Type of connection | Lₙ.d | Command or response |
| Utilization threshold | Lₙ.u | Megabits/Sec |
| Allowable latency | Lₙ.l | Nanoseconds |
| Bandwidth required | Lₙ.b | Megabits/Sec |

### The Derive Connectivity Network Process

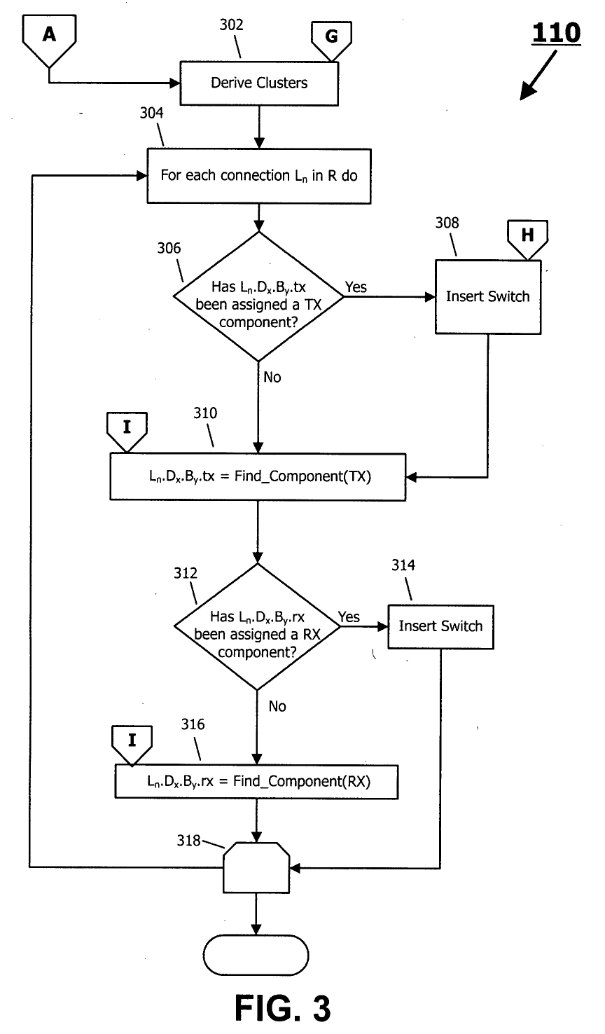

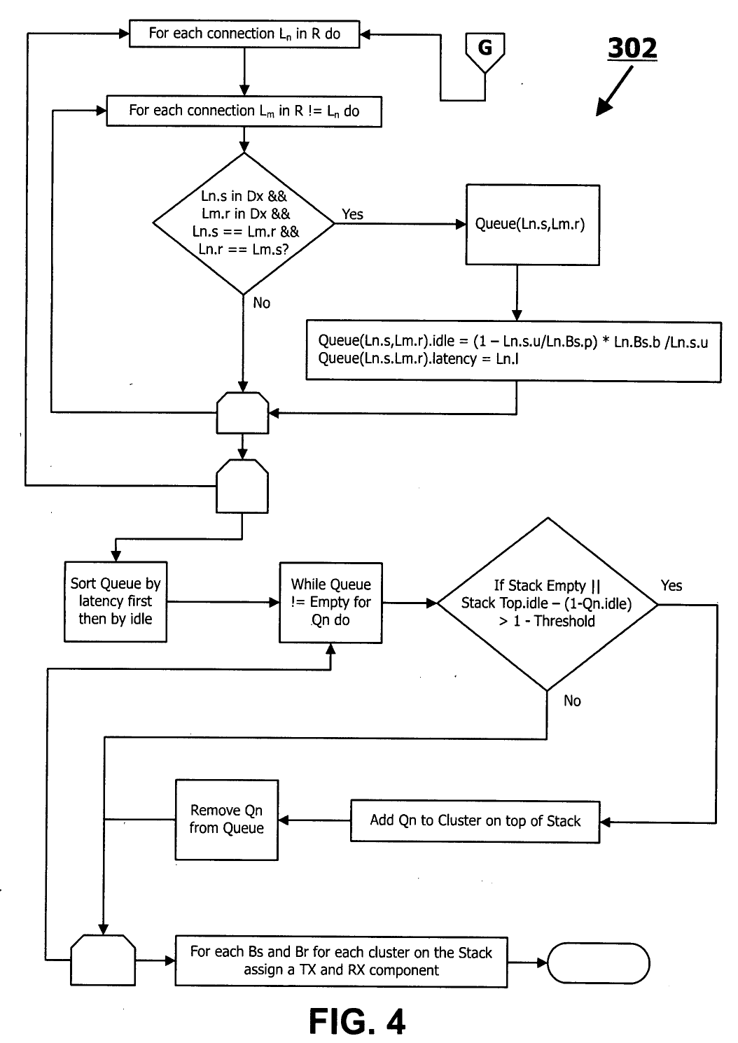

Looking to FIG. 3, the “derive connectivity network process” 110 creates the first approximation of a completely functional, though perhaps suboptimal, ANoC network. At step 302 the cluster derivation process, detailed further in FIG. 4, is primarily an area optimization that looks for opportunities to combine a set of processing blocks S={Bx.Bz} within the same domain Dn such that the total bandwidth of S does not exceed the bandwidth of the TX and RX components assigned to the cluster, thus allowing the TX and RX units to be shared by multiple processing blocks. The cluster derivation process 302 uses TDM techniques to minimize the likelihood of arbitration between the processing blocks within S, and utilizes the concept of communication locality to provide candidate processing blocks.

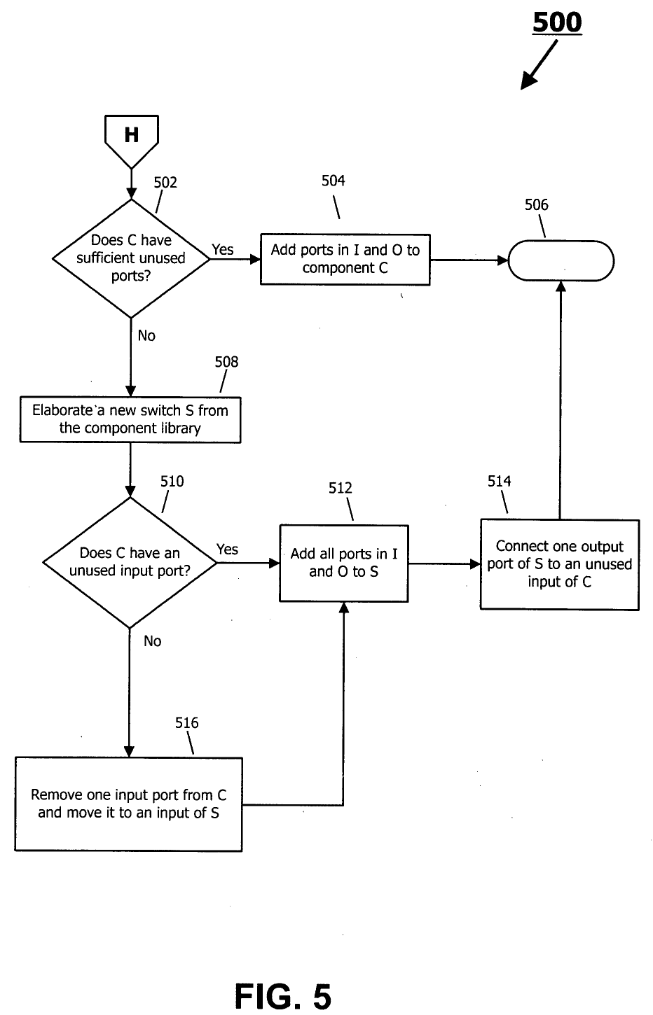

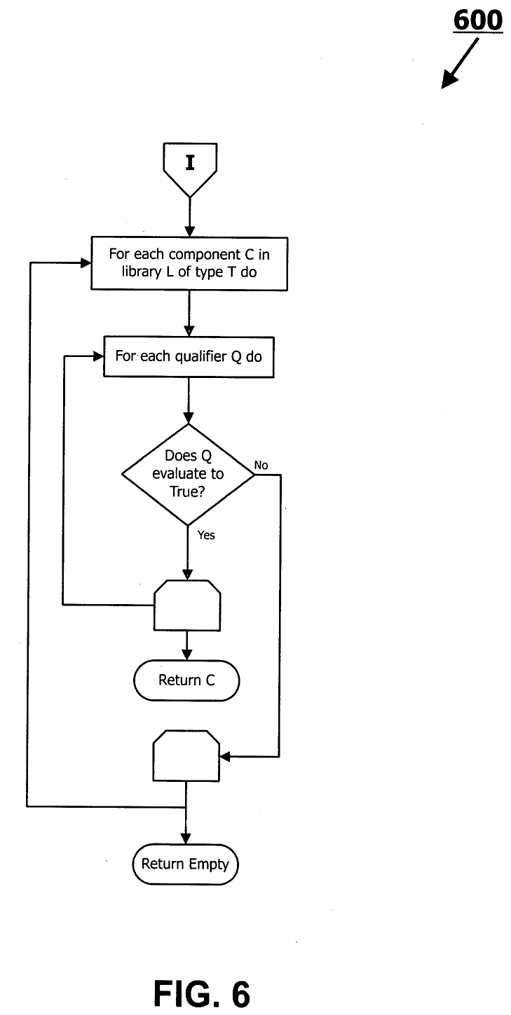

Returning to FIG. 3, once clusters have been derived (step 302) a TX (transmitter) and RX (receiver) component is selected for each cluster. Starting at step 304, at step 306 we look to see if a cluster has been assigned a TX component. If not, we go to step 310 “find component”, a subroutine 600 detailed in FIG. 6. The find component process 600 looks for a suitable component within the component library 102. As this process is used in generating both the connectivity network (step 110) and the optimized network (step 114), a simple search algorithm will not suffice. Therefore, the find component process 600 supports a variable length list of qualifications in order to properly qualify or discard component candidates. This process must be general in nature as library components are not guaranteed to exist in all cases. FIG. 6 describes the process 600 of looking through each component (C) listed in the component library 102 (L) for the desired component type (T), which at the process step 310 is a TX component. Hereinafter “find component” will be described as a subroutine 600 and the desired component to be found is simply the argument passed to logic flow 600. If step 306 determines that a TX component has been assigned to the instant component (in a previous iteration of the loop comprising steps 304 to 318) the TX component is checked at step 308 to see if an additional switch is needed, step 308 detailed further in FIG. 5 as logical flow 500.

As shown in FIG. 5, step 502 tests to determine if the component (C) already has sufficient unused ports to satisfy the requirements for the instant component. If so, input and output ports (I and O respectively) are added to the component C attributes, as previously discussed in conjunction with FIG. 2, and the process terminates (returns) at step 506. If a component does not have sufficient unused ports, a switch is elaborated from the component library at step 508, then step 510 tests to determine if the component (C) has an unused input port. If so, all input and output ports are added to newly elaborated switch S at step 512, then one output from the switch (S) is connected to the unused input of the component (C) at step 514. If the component does not have an unused input (step 510=FALSE) an existing input port on the component is moved to an input on the inserted switch (S) at step 516 thereby providing additional input ports and continuing on to steps 512 and 514.

Returning to FIG. 3, step 312 similarly checks to see if the instant cluster has been assigned an RX component. If so, step 314 is again flow 500, if not an RX component is found at step 316 by flow 600. The process continues from step 318 back to step 304 until a basic connectivity network has been derived. By definition this means that all components have been connected as necessary; that is, the “n” connections in the requirements list 108 are connected by ANoC links. The results of process step 110 is a network file 112.

The switch insertion process, as shown in FIG. 5, implements fork (route) or join (merge) paths in an existing network. As this process is employed only during construction of the connectivity network, only the connectivity must be correct and constraints on latency, bandwidth, power and area are ignored. The results of this process will likely be an unbalanced tree with arbitrary paths shorter than others. This will be addressed in the switch balancing process.

### The Network Optimization Process

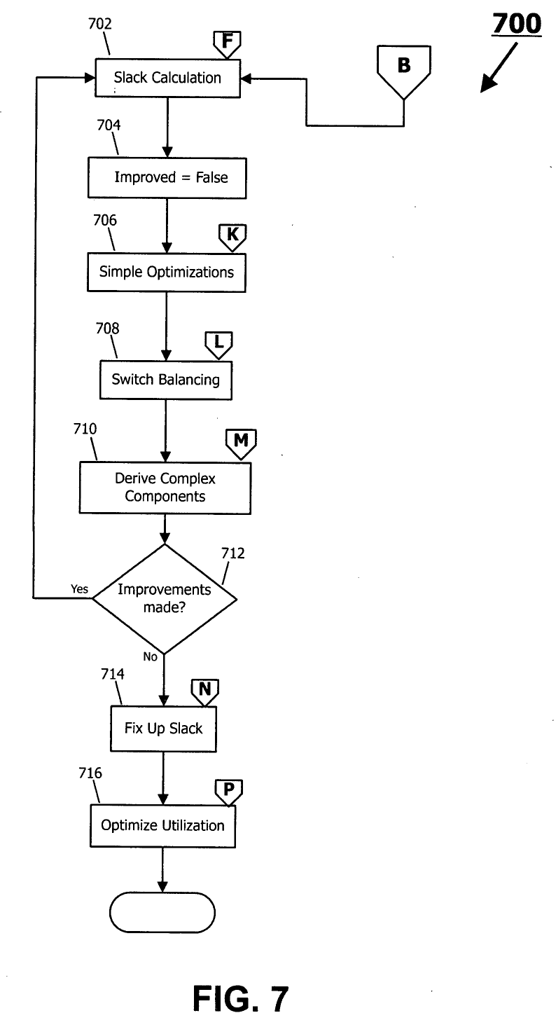

The network optimization process of FIG. 7 has several lower-level processes that are performed until the network can no longer be improved. Other processes, namely the fix up slack process (step 714) and the optimize utilization process (step 716) are performed once after all other optimizations have been performed.

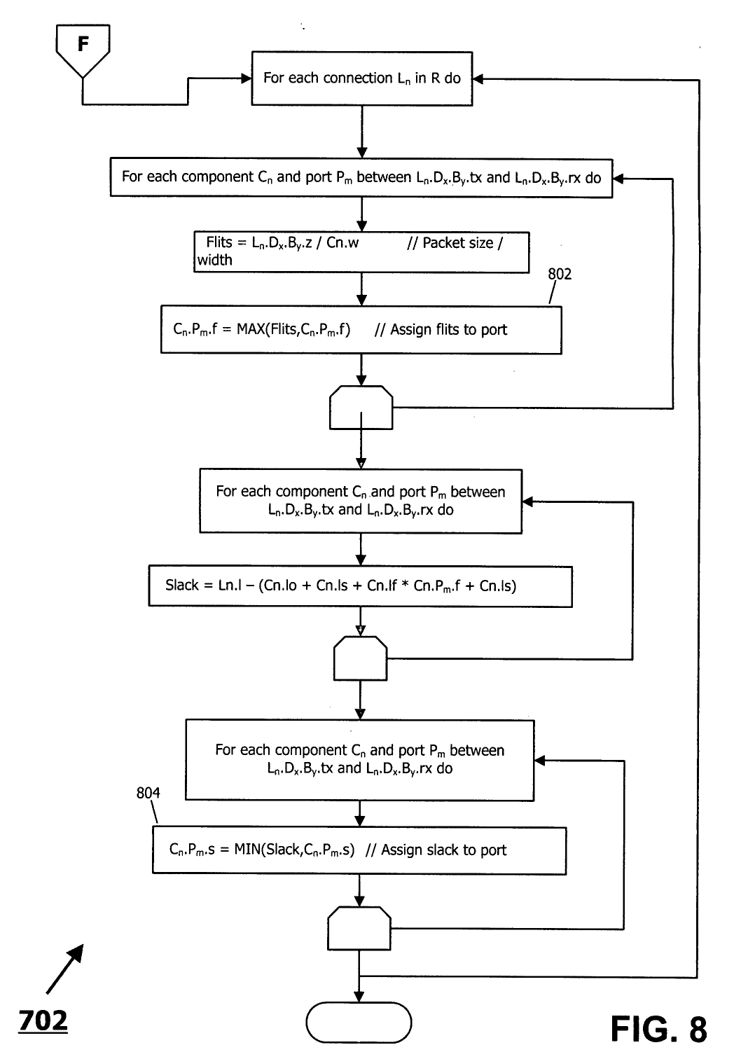

Referring to FIG. 8, the slack calculation process 702 assigns the worst-case latency slack (that is, the minimum slack available) to each output port of the instant network at step 804. The process utilizes the latency information inherited by each component when the component is elaborated. This process takes as input the requirements internal representation (R) and the instant network (N). The slack calculation process 702 also propagates the number of flits to the output ports of the network components N.Cn (step 802) as this is required for calculating the worst case slack for each component port. The flit calculation in step 802 is performed for each input port of component C and is defined as the maximum of the instant flit count calculated from the component width and the network path's packet size, and the instant flit count of the instant port.

Returning to FIG. 7, after the slack available has been found at step 702, the flag “Improved” is reset at step 704. The flag will be later set if and only if an improvement is made, allowing for a test (step 122) to determine if an iteration of the network optimization flow 114 has provided any improvement in the network connectivity design. Step 706, denominated the “simple optimization process”, looks for obvious, localized optimizations to network components that are the result of the connectivity network process 110 or later optimizations. There are five opportunities for improvements to be made (steps 902, 904, 906, 908, and 910). Step 902 checks for redundant input connections and, if found, removes them at step 903. Step 904 looks for duplicate output ports, step 906 looks to remove non-SERDES components with one input and one output and step 908 looks for a component that has no inputs or outputs. If any of these are TRUE the problem is rectified by removing the component or the unneeded link and the “improved” flag is set. Step 910 looks to see if the component switch has unused ports, and if TRUE a different switch with the appropriate number of ports is found (flow 600), replacing the instant switch. The process 706 loops from step 912 to step 914 until all components have been tested.

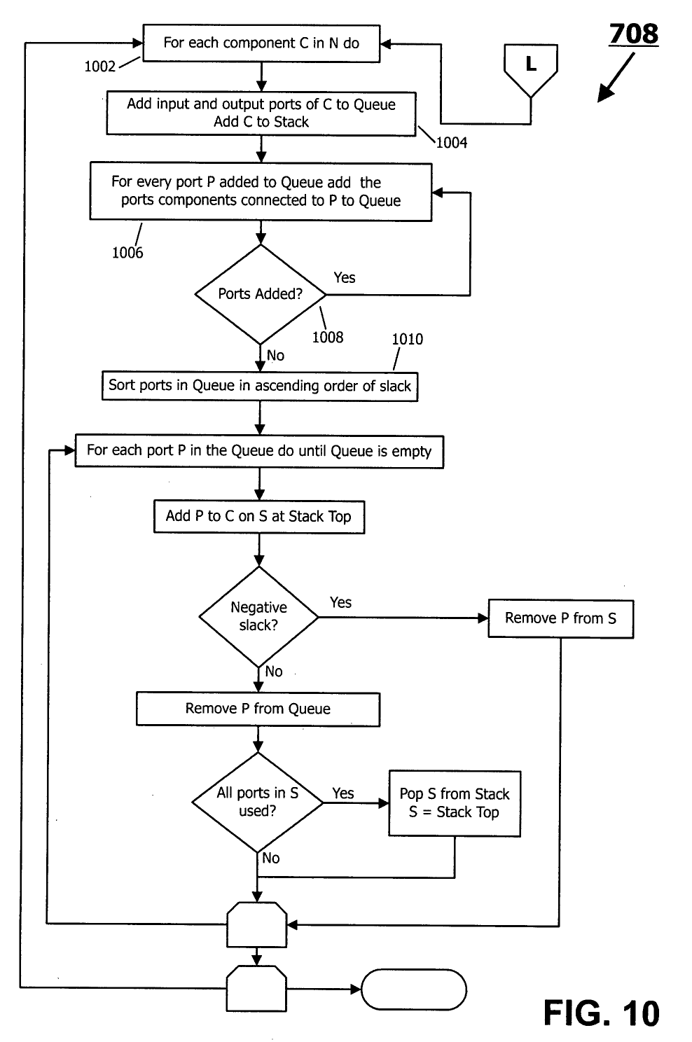

Returning to FIG. 7, step 708, denominated the “switch balancing process” follows step 706. Step 708 is detailed in FIG. 10. Several optimizations, particularly those that use the switch insertion process, result in an unbalanced network. An unbalanced network is one where similar paths from TX components to RX components have significantly different latency because the number of switch components each of the paths pass through is different. Most often, unbalanced network paths are serial in nature, and the switch balancing process 708 parallelizes them. Step 1004 puts all input and output ports (maintaining their associated attributes, including slack) into a queue plus pushes the component onto a stack. Step 1006 adds to the Queue the components pointed to by each port P of component C which was added to the Stack in step 1104. Step 1008 tests to determine if any ports were added to the Queue in step 1106. At step 1010 the ports are sorted in the ascending order of slack.

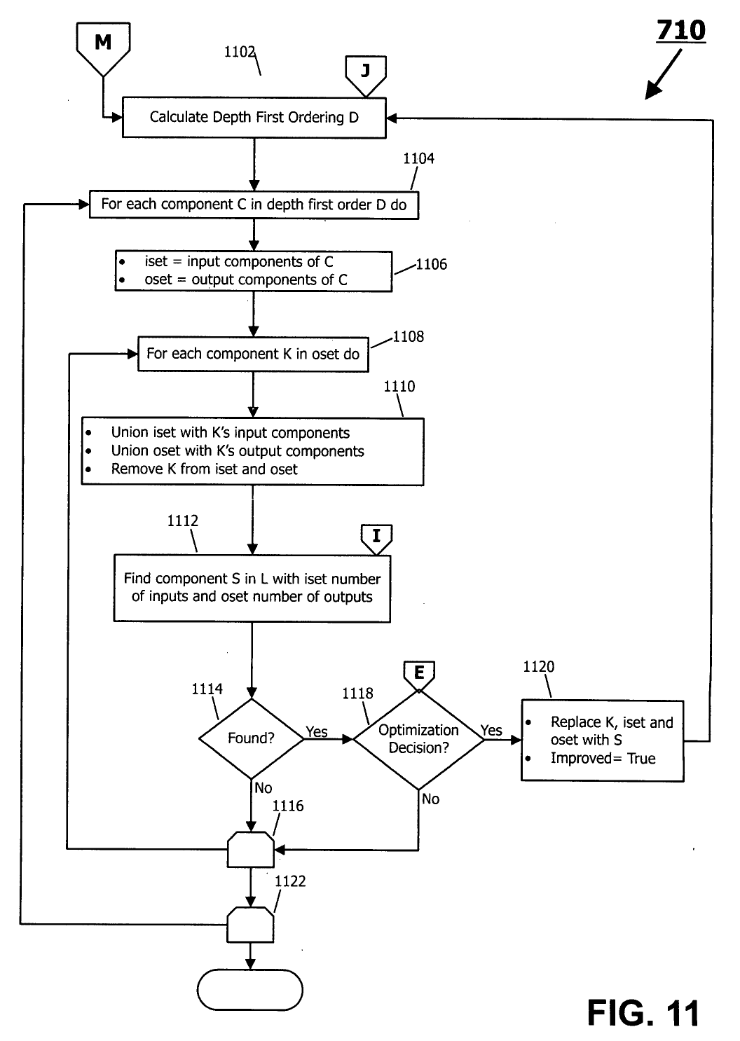

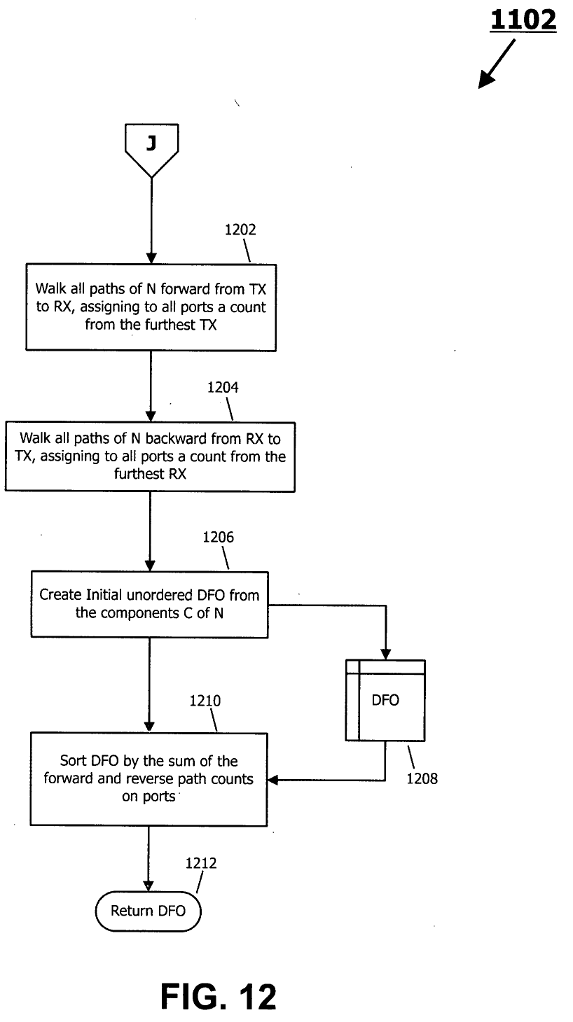

Returning again to FIG. 7, following step 708 is step 710, denominated a “derive complex components” process, which is detailed in FIG. 11. The derive complex components process 710 looks for opportunities to combine two or more components into one component without creating negative slack or causing the network to become over utilized. The first step in the derive complex components process 710 is to calculate a “depth first order” value for each component at step 1102. The depth first order process 1102 is detailed in FIG. 12. The DFO is an ordered set of components in a network such that those components with the greatest number of components away from the endpoints of the network are listed first. Many optimizations are performed iteratively until no more improvements can be made. When iteratively optimizing networks toward achieving bandwidth, latency and area constraints it is often important that the optimization be applied in the correct order. To achieve this, the network is passed to the depth first ordering process 1102 which returns the ordering of components (the DFO 1208) to which optimizations should be applied. A DFO 1208 is made at step 1206, then sorted in descending order (that is, largest count first), the list then returned at step 1212.

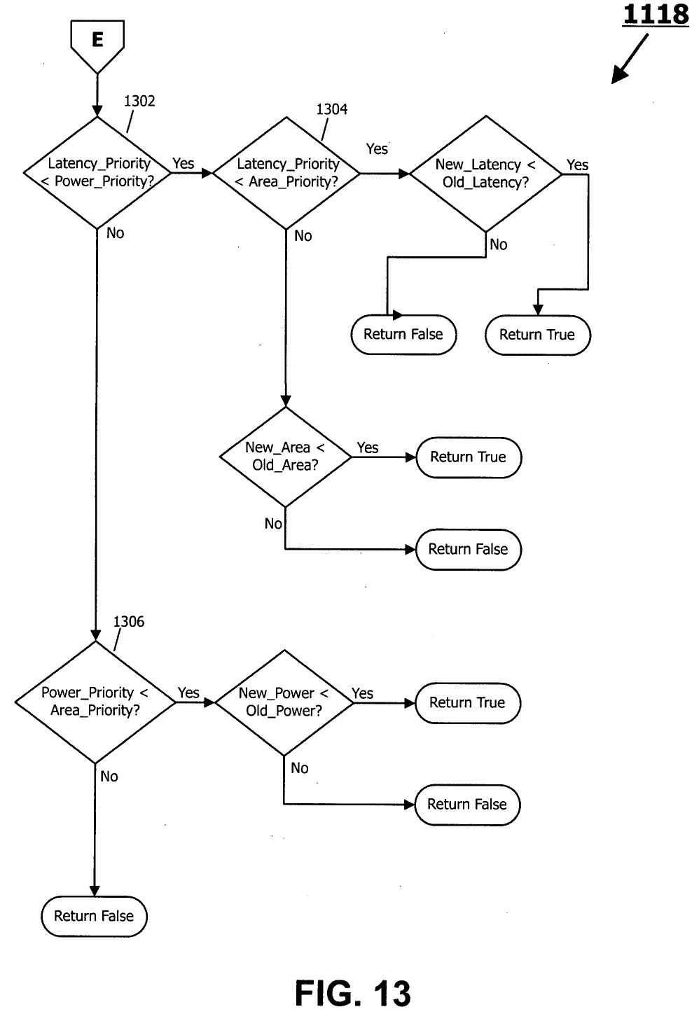

Returning to FIG. 11 (flow 710), going in depth first order, beginning at step 1104, the process seeks to find a single component capable of providing the functionality of a plurality of smaller components. The assumption is that a combined function will require less space, less power, or offer higher performance (less latency) than the same function provided by the collection of smaller functions. Step 1106 creates an input set (iset) and an output set (oset), then iterates through the oset as component “K”. For each K so formed (step 1108) a candidate complex component is described by making a logical union of K's input components with iset and K's output components with oset, then removing K at step 1110. A candidate component S is searched for by flow 600 “find component” search at step 1112. If a candidate component S is found step 1118 decides if the proposed substitution is consistent with the prioritized requirements of the network. Step 1118, denominated an “optimization decision process” and detailed further in FIG. 13, determines if substituting S for K will improve the network. Flow 1118 takes as input the priority levels for the three dimensions of optimization (latency, area and power) as well as current and proposed values for these three dimensions. Based on the dimension with the lowest priority level, the optimization decision process returns TRUE if the optimization should be performed, and FALSE if it should not.

Depending upon the prioritization, flow 1118 will return a TRUE or FALSE determination as to whether the component found by flow 600 (at step 1114) should be substituted for the collection of components represented by K. If so, this is done at step 1120 and the depth first ordering process repeated at step 1102, since the ordering will now have changed. Included in step 1120 is setting the “improved” flag. If the component found at step 1114 is rejected, the flow branches to step 1116 to continue the sifting process to look from another candidate component to replace the instant K functionality from step 1108. When the loop from 1108 to 1116 is complete, it is repeated again inside the loop formed by steps 1104 through 1122, thus evaluating all of the component list in depth first order.

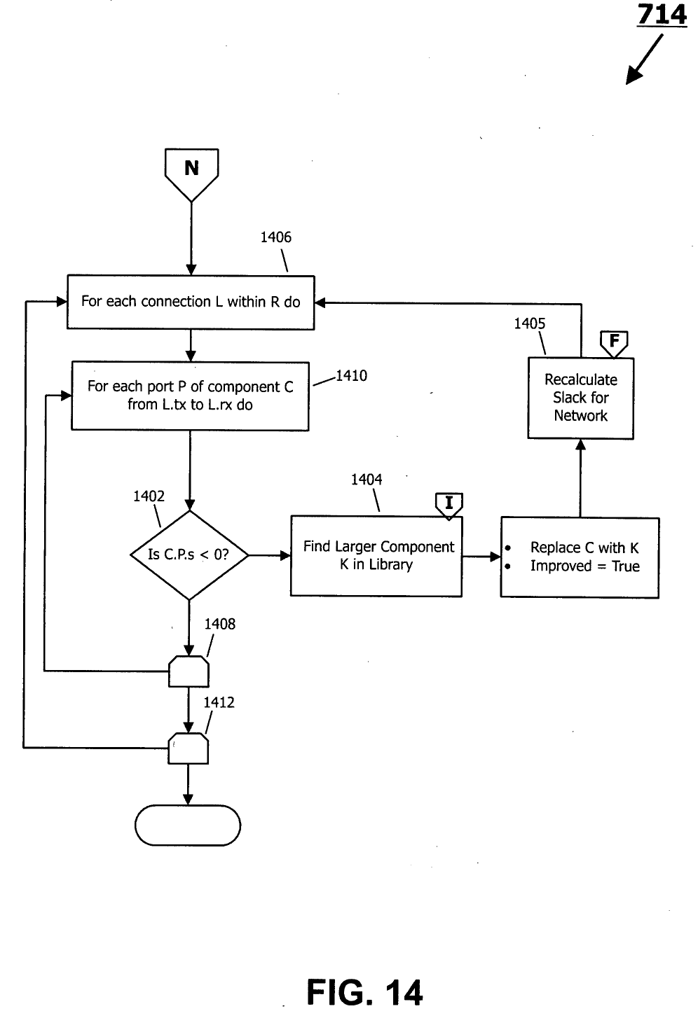

Again returning to FIG. 7, step 712 tests to see if any improvement has been made as a result of the flow 700. If TRUE, the process is repeated from step 702 until FALSE, signifying that no further improvement is available. It is possible that some error in slack (that is, any negative slack) has been introduced during the optimization process. FIG. 14 illustrates a “fix up slack process” 714, which walks the optimized network and increases the size of components in an attempt to resolve any negative slack situations that exist in the network. The test for each component's slack is step 1402. If negative slack is found step 1404 looks for a larger component in the component library (flow 600), replacing the instant component with that found by step 1404. Slack must be recalculated (step 1405, FIG. 8 again) and the process repeated from step 1406. The inner loop from step 1410 to 1408 is repeated until all ports are verified to have positive or zero slack, and the outer loop path from step 1406 to step 1412 until all components have likewise been checked.

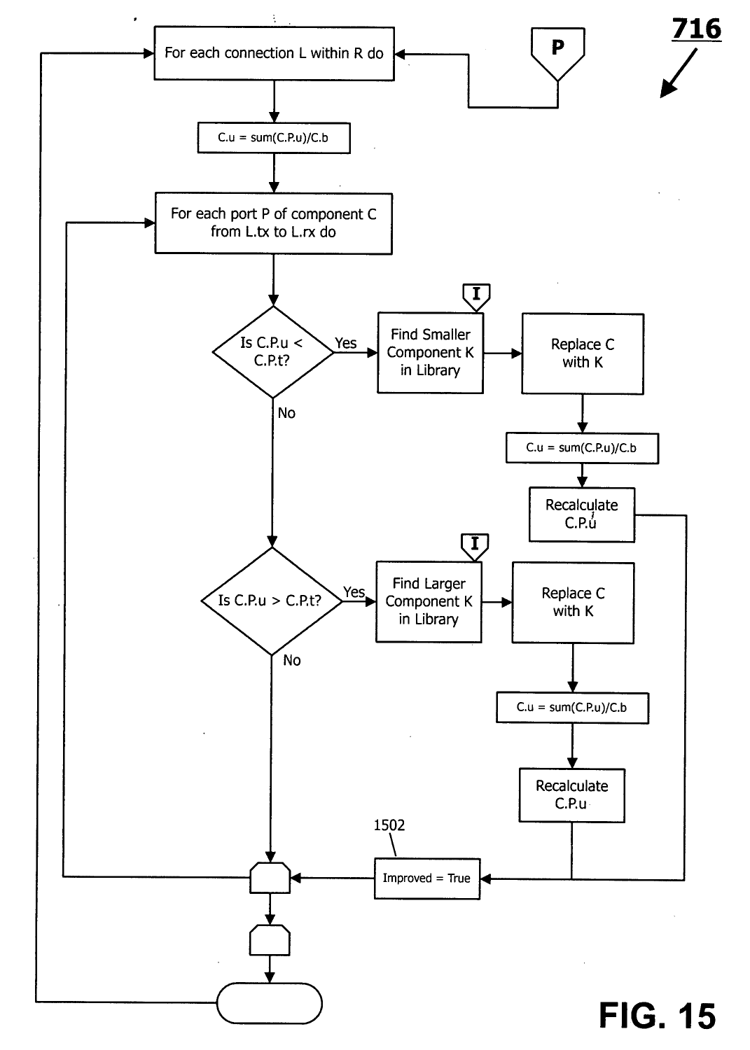

Returning to FIG. 7 once more, step 716 denominated the “optimize utilization process”, is detailed in FIG. 15, looks for paths within a network that are under utilized and attempts to use smaller components to reduce area without causing a negative slack situation. Conversely, the process also looks for paths that are over utilized and attempts to replace them with larger components. Note that if any substitutions are made the improved flag is set at step 1502. With the completion of step 716, flow 700 (step 114) is also complete, and an optimized network described by the optimized network file 116.

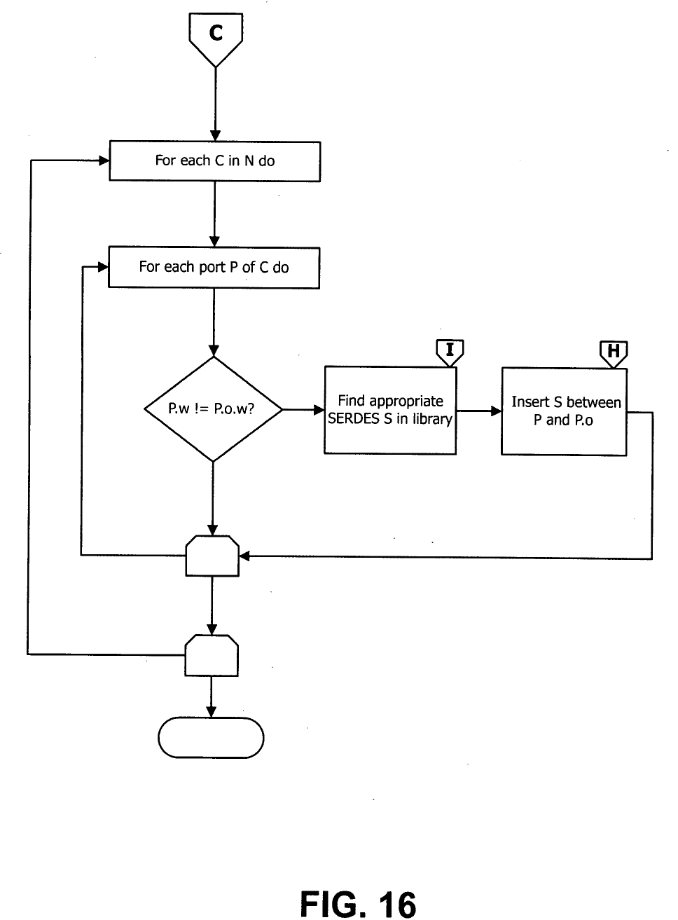

Looking again to FIG. 1, the insert SERDES process 118, as shown in FIG. 16, looks for output ports of components in the network that are connected to input ports of components of different width. The process then inserts the appropriate SERDES components as necessary to narrow or widen the links between components.

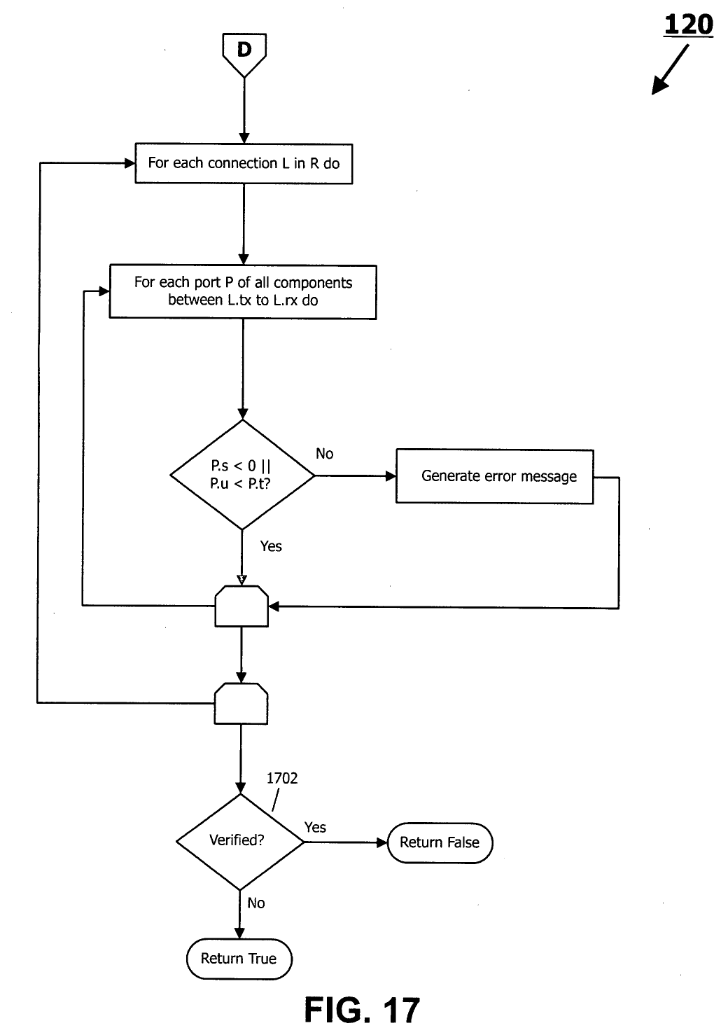

The verify network process 120, detailed in FIG. 17, looks at the actual network paths for each connection L from L.tx to L.rx and ensures that the path exists, meets the bandwidth requirement of L.b, meets the latency requirement of L.l, and at no point in the network does the utilization exceed the requirement in L.u. Note that the slack (P.s) for each port P of the components between L.tx and L.rx are relative to the connection latency L.I. Therefore, all that needs to be checked in terms of the latency requirement is that P.s is not negative. Similarly, P.u holds the utilization of the network at port P between L.tx and L.rx so verification that L.b is met can be done simply by comparing P.u with the threshold (P.t), and if P.u is less than P.t then the bandwidth requirements have been met. The results of the verify network process 120 is step 1702, which returns TRUE if no errors have been generated, FALSE if errors generated. If step 1702 is FALSE, a branch is taken to step 122 to check for any improvement. If the improved flag is TRUE, then the process returns to step 114 to try again to find an optimized network that will verify with no errors at step 1702. If improved=FALSE, it is known that there does not exist a solution for the network which meets the requirements list 108 using the components library 102. The generate errors and warnings process 124 writes to the report file 126 any bandwidth or latency constraints that could not be met by the network optimization process.

If step 1702 is TRUE, the process terminates successfully, branching to step 128 to generate a network fabric using industry standard methods, culminating with a fabric file at step 132. The generate network fabric process 128 simply takes the optimized network stored in internal memory and writes it to a fabric file in an appropriate format, for example a Verilog netlist.

### Reservation of Extra-Patent Rights, Resolution of Conflicts, and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

Unless expressly stated otherwise herein, ordinary terms have their corresponding ordinary meanings within the respective contexts of their presentations, and ordinary terms of art have their corresponding regular meanings

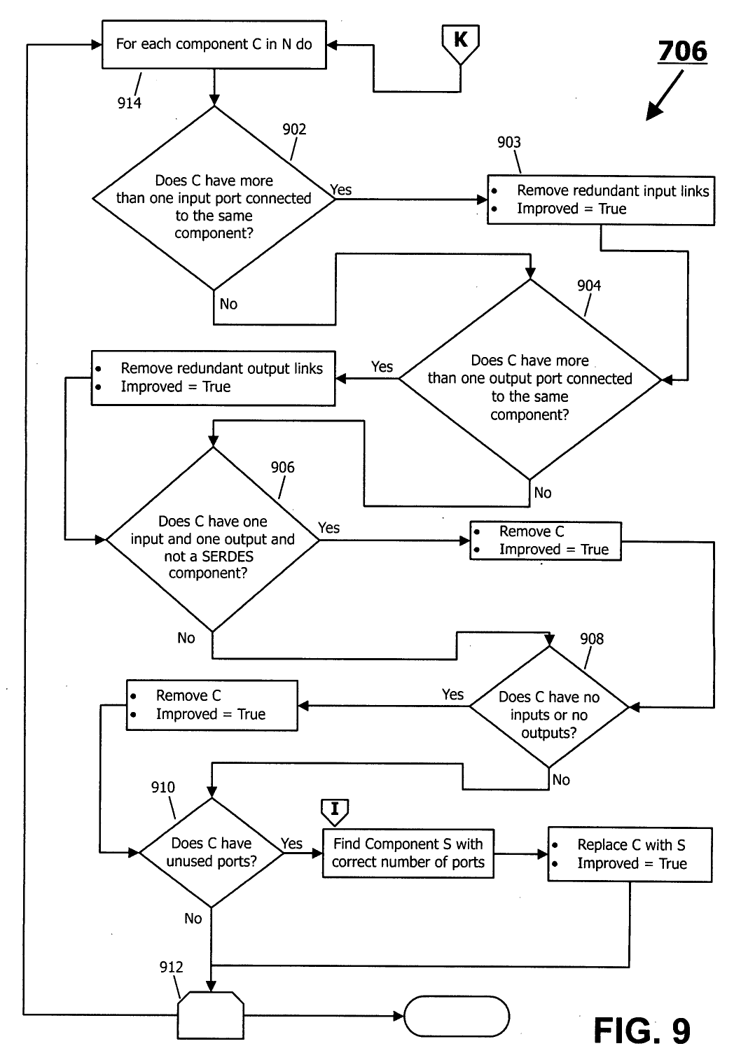

APPENDIX I
Input and Output Term Assumptions For Drawings

| Drawing | Input Terms | Output Terms |
|---|---|---|
| FIG. 3 | Library of components Cn | Network N |
| | Requirements R with | |
| | connections Ln | |
| FIG. 4 | Connections Ln within R | Pre-assigned TX and RX |
| | requirements | components to blocks Bn |
| | | within the cluster |
| FIG. 5 | Set of input ports I needed | Modified network N |
| | Set of output ports O needed | |
| | Component C to be adjusted | |
| | Network N | |
| | Component library L | |
| FIG. 6 | Component type T | Qualified component Q or |
| | List of qualifiers Q | Empty if no suitable |
| | Component library L | component is found |
| FIG. 7 | Network N of components C | Optimized network N |
| | Component library L | |
| FIG. 8 | Network N with components Cn | Network N augmented |
| | Requirements R with | with slack information |
| | connections Ln | |
| FIG. 9 | Network N with components C | Improved Network N |
| FIG. 10 | Network N of components C | Network N with balanced |
| | with slack calculated | paths through all |
| | for all ports of C | components C |
| FIG. 11 | Network N with components C | Improved network N with |
| | Library of components L | modified components C |
| FIG. 12 | Network N with components C | Depth first ordering O |
| FIG. 13 | Latency_Priority | N/A |
| | Area_Priority | |
| | Power_Priority | |
| | New_Latency | |
| | Old_Latency | |
| | New_Area | |
| | Old_Area | |
| | New_Power | |
| | Old_Power | |
| FIG. 14 | Network N with components C | Network N with modified |
| | Requirements R with | components C |
| | connections L | |
| FIG. 15 | Network N with components C | Network N with modified |
| | Requirements R with | components C |
| | connections L | |
| FIG. 16 | Network N with components C | True if all requirements |
| | Requirements R with | met, else False |
| | connections L | |
| FIG. 17 | Network N with components C | Network N with |
| | | components C including |
| | | SD components where |
| | | needed |

We claim:

1. A method for synthesizing an asynchronous network on chip interconnect, comprising the steps of:
a. providing a list of system communications requirements;
b. providing a library of electronic components;
c. selecting components from the library of components, using said components to form a connectivity network that satisfies the requirements of the system communications list;
d. optimizing the connectivity network;
e. inserting additional components from the library wherein said additional components are selected in accordance with the optimizing step;
f. comparing the resulting network to the list of system communications requirements; and
g. generating a network fabric.

2. The method according to claim 1, wherein said electronic component library comprises components which have been previously characterized for a certain semiconductor process.
